(19) United States
(12) Patent Application Publication
(10) Pub. No.: US 2014/0216577 A1
(43) Pub. Date: Aug. 7, 2014

(54) GAS RELEASE DEVICE FOR COATING PROCESS

(71) Applicant: ADPV TECHNOLOGY LIMITED, Apia (WS)

(72) Inventors: Shiezen Steven HUANG, Redondo Beach, CA (US); Ke-Feng LIAO, Central Hong Kong (CN); Wen-Bo LAI, Central Hong Kong (CN); Kwan-Kin CHAN, Central Hong Kong (CN); Sheng LI, Central Hong Kong (CN); Liang MENG, Ningbo City (CN); Jhao-Lung ZENG, Taipei City (TW); Guan-Bi CHEN, Ningbo City (CN)

(73) Assignee: ADPV TECHNOLOGY LIMITED, Apia (WS)

(21) Appl. No.: 14/166,704

(22) Filed: Jan. 28, 2014

(30) Foreign Application Priority Data
Feb. 1, 2013 (TW) 102104036

(51) Int. Cl. B05C 11/10

(52) U.S. Cl. CPC B05C 11/1002
USPC 137/561 A

(57) ABSTRACT

A gas release device is formed of two plates combined together. Each of the plates includes an intake groove. Each of the intake grooves is linked with a first distribution groove. Each of the first distribution grooves is linked with two second distribution grooves. Each of the second distribution grooves is linked with two third distribution grooves. Each of the third distribution grooves is linked with two fourth distribution grooves. Each of the fourth distribution grooves is linked with two fifth distribution grooves. Each of the fifth distribution grooves has a venthole. After a gas of a vapor deposition source enters the intake groove, the gas passes through the first, second, third, fourth, and fifth distribution grooves in order and then substantially equal amount of the gas is finally released out of each of the ventholes.

### BACKGROUND OF THE INVENTION

1. Field of the Invention

The present invention relates generally to a coating process and more particularly, to a gas release device for a coating process.

2. Description of the Related Art

The so-called vacuum coating process is to put a workpiece, such as a substrate, into a vacuum chamber and then heat a vapor deposition source, such as selenium, to make it vaporized and sublimated to further make the gas of the vapor deposition source attached to the surface of the workpiece for forming a thin film on the surface of the workpiece.

However, during the current coating process, it is necessary to wait until the gas of the vapor deposition source is attached to the surface of the workpiece on its own, so it is quite time-consuming Besides, the thickness of the thin film formed on the surface of the workpiece is subject to nonuniformity to further adversely affect the quality of the thin film formed by the coating process.

### SUMMARY OF THE INVENTION

The primary objective of the present invention is to provide a gas release device which can enhance uniformity of thickness of a thin film to heighten the quality of a coating process.

The foregoing objective of the present invention is attained by the gas release device formed of two plates, each of which includes a top side, a bottom side, and a joint lateral abutting against the top and bottom sides. The two plates are combined together in a way that the respective joint laterals cling to each other. Each of the joint laterals includes an intake groove and an inlet formed on a top end of the intake groove and located at the top side of each plate. Each of the intake grooves has a bottom end linked with a first distribution groove. Each of the first distribution grooves has two ends linked with two second distribution grooves of the same plate, respectively. Each of the second distribution grooves has two ends linked with two third distribution grooves of the same plate, respectively. Each of the third distribution grooves has two ends linked with two fourth distribution grooves of the same plate, respectively. Each of the fourth distribution grooves has two ends linked with two fifth distribution grooves of the same plate, respectively. Each of the fifth distribution grooves has a venthole formed on a bottom end thereof After a gas of a vapor deposition source enters the intake groove through the inlet, the gas is averagely distributed by the first distribution groove, the second distribution grooves, the third distribution grooves, the fourth distribution grooves, and the fifth distribution grooves and then substantially equal amount of the gas is finally released out of each of the ventholes. In this way, uniformity of thickness of the thin film can be effectively enhanced for preferably high-quality coating process.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is another perspective view of the preferred embodiment of the present invention.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

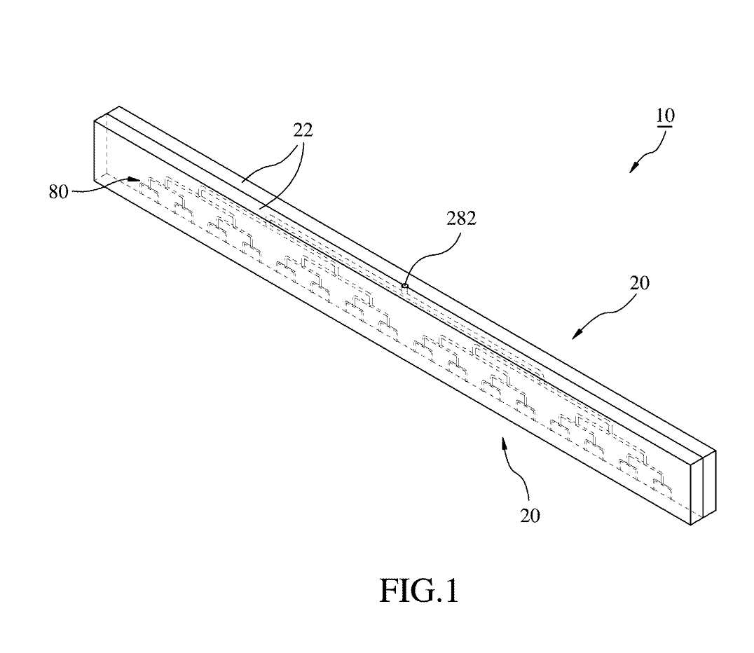

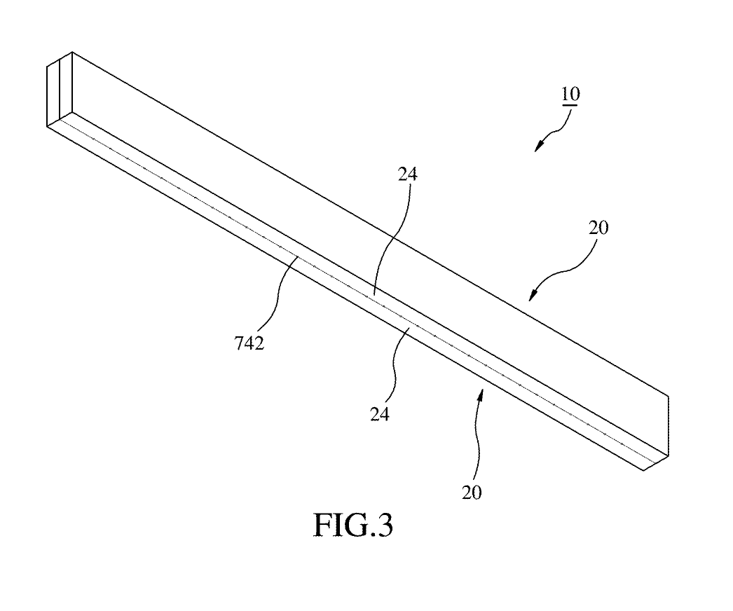

Referring to FIGS. 1-3, a gas release device 10 constructed according to a preferred embodiment of the present invention is applied to a vacuum coating process.

The gas release device 10 can be applied to either of coating processes under the environment of other gases as it actually depends. The gas release device 10 is formed of two plates 20. Each of the plates 20 is a rectangular member made of a refractory and corrosion-resistant material and includes a top side 22, a bottom side 24, and a joint lateral 26 vertically abutting against the top and bottom sides 22 and 24. The detailed descriptions and operations of these elements as well as their interrelations are recited in the respective paragraphs as follows.

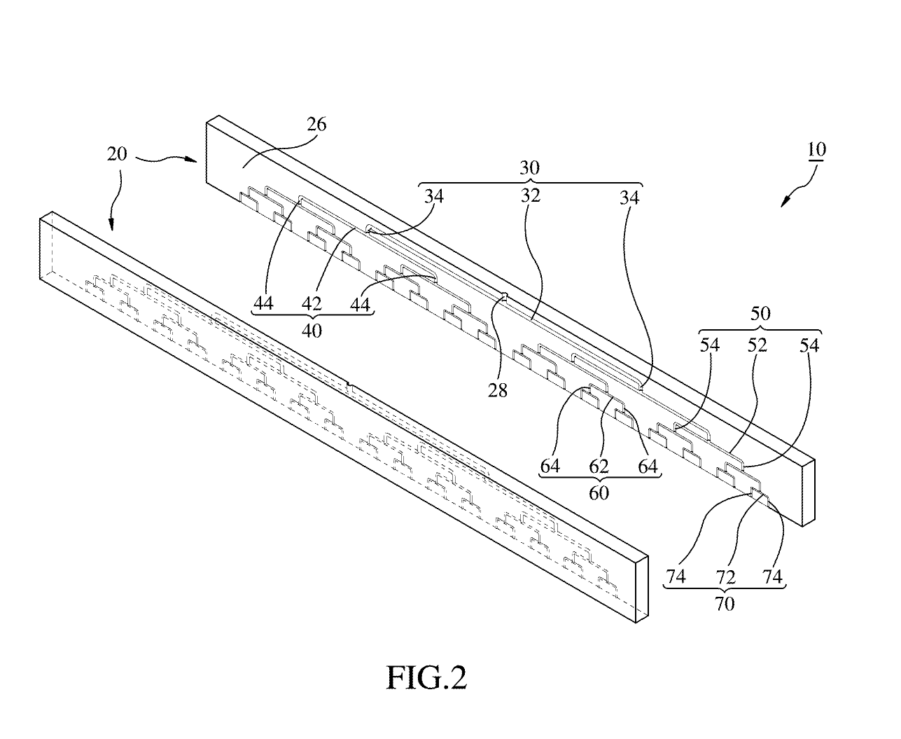

The joint lateral 26 of each plate 20 includes an intake groove 28 and an inlet 282 formed on a top end of the intake groove 28 and located at the top side 22 of each plate 20. Each of the intake grooves 28 has a bottom end linked with a center of a first transversal section 32 of the same joint lateral 26. The first transversal section 32 has two ends, each of which is linked with a first longitudinal section 34 of the same joint lateral 26. The first transversal section 32 and the two longitudinal sections 34 of the same joint lateral 26 jointly define a first distribution groove 30. Each of the first longitudinal sections 34 has a bottom end linked with a center of a second transversal section 42 of the same joint lateral 26. Each of the second transversal sections 42 has two ends, each of which is linked with a second longitudinal section 44 of the same joint lateral 26. Each of the second transversal sections 42 and the corresponding second longitudinal sections 44 of the same joint lateral 26 jointly define a second distribution groove 40. Each of the second longitudinal sections 44 has a bottom end linked with a center of a third transversal section 52 of the same joint lateral 26. Each of the third transversal sections 52 has two ends, each of which is linked with a third longitudinal section 54 of the same joint lateral 26. Each of the third transversal sections 52 and the corresponding two third longitudinal sections 54 jointly define a third distribution groove 50. Each of the third longitudinal sections 54 has a bottom end linked with a center of a fourth transversal section 62 of the same joint lateral 26. Each of the fourth transversal sections 62 has two ends, each of which is linked with a fourth longitudinal section 64 of the same joint lateral 26. Each of the fourth transversal sections 62 and the corresponding two fourth longitudinal sections 64 jointly define a fourth distribution groove 60. Each of the fourth longitudinal sections 64 has a bottom end linked with a center of a fifth transversal section 72 of the same joint lateral 26. Each of the fifth transversal sections 72 has two ends, each of which is linked with a fifth longitudinal section 74 of the same joint lateral 26. Each of the fifth transversal sections 72 and the corresponding two fifth longitudinal sections 74 jointly define a fifth distribution groove 70. Each of the fifth longitudinal sections 74 has a venthole 742 formed on a bottom end thereof and located at the bottom side 24 of each plate 20, as shown in FIG. 2.

Each of the intake grooves 28, the first distribution potions 30, the second distribution grooves 40, the third distribution grooves 50, the fourth distribution grooves 60, and the fifth distribution grooves 70 is provided with a semi-circular cross-section in this preferred embodiment. However, each of the aforesaid cross-sections is not limited to the semi-circular shape and can be rectangular shape or in the shape of other geometric figures. However, each of the intake grooves 28 is identical to either of the first distribution grooves 40 in diameter, each of the first distribution grooves 30 is larger than either of the second distribution grooves 40 in diameter, each of the second distribution grooves 40 is larger than either of the third distribution grooves 50 in diameter, each of the third distribution grooves 50 is larger than either of the fourth distribution grooves 60 in diameter, and each of the fourth distribution grooves 60 is larger than either of the fifth distribution grooves 70 in diameter.

In assembly, the two plates 20 are combined together in a way that the two joint laterals 26 cling to each other. The intake grooves 28, the first distribution grooves 30, the second distribution grooves 40, the third distribution grooves 50, the fourth distribution grooves 60, and the fifth distribution grooves 70 jointly form a distribution passage 80, as shown in FIG. 1.

In light of the structure mentioned above, the gas of the vapor deposition source can enter the distribution passage 80 formed of the intake grooves 28 and the first, second, third, fourth, and fifth distribution grooves 30, 40, 50, 60, 70 through the inlets 282 and then be jointly released to the surface of a workpiece through the ventholes 742. Since the first distribution grooves 30, the second distribution grooves 40, the third distribution grooves 50, the fourth distribution grooves 60, and the fifth distribution grooves 70 are a geometric progression in number and distributed symmetrically, the path from each of the inlets 282 to either of the ventholes 742 has the same length to make the amount of the gas released through each venthole 742 substantially equal. In this way, the gas of the vapor deposition source will form a thin film with uniform thickness on the surface of the workpiece for enhanced quality and efficiency of the coating process.

What is claimed is:

1. A gas release device for a coating process, the gas device comprising two plates, each of which has a top side, a bottom side, and a joint lateral abutting against the top and bottom sides, the two plates being combined together in a way that the respective laterals cling to each other, each of the joint laterals having an intake groove and an inlet formed on a top end of the intake groove and located at the top side of each plate, each of the intake grooves having a bottom end linked with a first distribution groove, each of the first distribution grooves having two ends, each of which is linked with a second distribution groove, each of the second distribution grooves having two ends, each of which is linked with a third distribution groove, each of the third distribution grooves having two ends, each of which is linked with a fourth distribution groove, each of the fourth distribution grooves having two ends, each of which is linked with a fifth distribution groove, each of the fifth distribution grooves having a venthole formed on a bottom end thereof and located at the bottom side of each plate.

2. The gas release device as defined in claim 1, wherein each of the intake grooves, the first distribution grooves, the second distribution grooves, the third distribution grooves, the fourth distribution grooves, and the fifth distribution grooves comprises a semi-circular cross-section.

3. The gas release device as defined in claim 2, wherein each of the intake grooves is equal to either of the first distribution grooves in diameter, each of the first distribution grooves is larger than either of the second distribution grooves in diameter, each of the second distribution grooves is larger than either of the third distribution grooves in diameter, each of the third distribution grooves is larger than either of the fourth distribution grooves in diameter, and each of the fourth distribution grooves is larger than either of the fifth distribution grooves in diameter.

4. The gas release device as defined in claim 3, wherein each of the first distribution grooves comprises a first transversal section and two first longitudinal sections, each of the intake grooves having a bottom end linked with a center of the first transversal section of the same first distribution groove, each of the first transversal sections having two ends, each of which is linked with one of the first longitudinal sections of the same first distribution groove, each of the second distribution grooves comprising a second transversal section and two second longitudinal sections, each of the first longitudinal sections having a bottom end linked with a center of one of the second transversal sections of the same second distribution groove, each of the second transversal sections having two ends, each of which is linked with one of the second longitudinal sections of the same second distribution groove, each of the third distribution grooves having a third transversal section and two third longitudinal sections, each of the second longitudinal having a bottom end linked with a center of one of the third transversal sections of the same third distribution groove, each of the third transversal sections having two ends, each of which is linked with one of the third longitudinal sections of the same third distribution groove, each of the fourth distribution grooves having a fourth transversal section and two fourth longitudinal sections, each of the third longitudinal sections having a bottom end linked with a center of one of the fourth transversal section of the same fourth distribution groove, each of the fourth transversal sections having two ends, each of which is linked with one of the fourth longitudinal sections of the same fourth distribution groove, each of the fifth distribution grooves having a fifth transversal section and two fifth longitudinal sections, each of the fourth longitudinal sections having a bottom end linked with a center of one of the fifth transversal sections of the same fifth distribution groove, each of the fifth transversal sections having two ends, each of which is linked with one of the fifth longitudinal sections of the same fifth distribution groove; each of the ventholes is formed on a bottom end of one of the fifth longitudinal sections of the same fifth distribution groove.
